(19) United States
(12) Patent Application Publication
(10) Pub. No.: US 2024/0373933 A1
(43) Pub. Date: Nov. 14, 2024

(54) INDUCTIVE HEATING AEROSOL-GENERATING SYSTEM WITH NICOTINE TAPE

(71) Applicant: PHILIP MORRIS PRODUCTS S.A., Neuchâtel (CH)

(72) Inventors: Jerome Christian COURBAT, Cortaillod (CH); Guillaume FREDERICK, Valff (FR); Irene TAURINO, Leuven (BE)

(21) Appl. No.: 18/690,439

(22) PCT Filed: Sep. 2, 2022
(86) PCT No.: PCT/IB2022/058270

§ 371 Date: Mar. 8, 2024

(30) Foreign Application Priority Data
Sep. 9, 2021 (EP) 21195763.4

(51) Int. Cl. A24F 40/465; A24B 15/167; A24F 40/20; A24F 40/42; H05B 6/10

(52) U.S. Cl. CPC A24F 40/465; A24B 15/167; A24F 40/20; A24F 40/42; H05B 6/108

(57) ABSTRACT

An aerosol-generating system that includes an inductive heating element in an aerosol-generating device that receives a replaceable aerosol-generating article. The replaceable aerosol-generating article includes an aerosol-generating substrate on a tape. A plurality of ferritic stainless-steel beads is disposed within the aerosol-generating substrate or within the tape.

The present disclosure relates to an aerosol-generating system with nicotine tape, the aerosol-generating system is configured to generate aerosol via inductive heating of the nicotine tape.

Sensorial media of commercial electronic cigarettes are generally liquid (so called “e-liquids”). These e-liquids are typically contained in aerosol-generating articles or “pods” that are replaceable into the electronic cigarette. These pods include a heater in contact with a porous material or wick. This porous material or wick transports e-liquid by capillarity action to the heater for vaporization into inhalation airflow of the electronic cigarettes.

A well-known problem of commercial electronic cigarettes is e-liquid leakage which typically occurs when: there is too much e-liquid; the retention capability of the porous material does not prevent the e-liquid from flooding especially in the case of full tank commercial electronic cigarettes; changes occur in environmental pressure during storage or transport; or temperature changes which affects the viscosity of the e-liquid or the retention capacity of the porous materials.

In addition, the heater of current commercial electronic cigarette systems is typically integrated in the replaceable cartridge or “pod” containing the e-liquid. Including the heater in the replaceable aerosol-generating article or “pod” increases the cost, complexity, and disposal costs of these replaceable aerosol-generating articles or “pods”.

There is a need for an aerosol-generating system that is stable and does not leak liquid. There is a need for a replaceable aerosol-generating article that does not include a heating element.

It is desirable to provide an aerosol-generating system that utilizes a stable aerosol-generating substrate in the replaceable aerosol-generating article. It is desirable to provide the aerosol-generating substrate on a tape. The tape may have multiple layers. It is desirable to provide an aerosol-generating system that includes an inductive heater, or inductive heating element, in the aerosol-generating device that receives the replaceable aerosol-generating article. The inductive heater may be a work coil which generates an alternating magnetic field when an alternating current flows through the coil. This alternating magnetic field induces eddy currents in susceptor materials that are positioned within the generated magnetic field. The eddy currents cause the susceptor materials to heat up. The heated susceptor materials provide heat to the aerosol-generating substrate. When the aerosol-generating substrate is heated, the aerosol-generating substrate releases volatile compounds from the aerosol-generating substrate to form an aerosol. When the aerosol is caught up in the flow of air moving along the airflow channel, the aerosol is delivered to the air outlet for inhalation by a user. When the susceptor material is within the generated magnetic field, it is “in magnetic contact” or “magnetically coupled” with the inductive heater.

It is desirable to provide an aerosol-generating system that includes an inductive heater magnetically coupled to ferritic stainless-steel beads dispersed within the aerosol-generating substrate.

This disclosure is directed to an aerosol-generating system that includes an inductive heating element in the aerosol-generating device that receives the replaceable aerosol-generating article. The replaceable aerosol-generating article includes a tape having an aerosol-generating substrate on the tape. A susceptor such as, ferritic stainless-steel beads, for example are dispersed within the aerosol-generating substrate or within the tape.

According to an aspect of the present invention, there is provided an aerosol-generating system including an aerosol-generating device and a replaceable cartridge. The aerosol-generating device includes a housing having an air outlet and an air inlet, an airflow channel fluidly connecting the air outlet with the air inlet. The aerosol-generating device includes an inductive heating element coupled to the housing and along the airflow channel, a cartridge receiving cavity defined withing the housing and configured to receive a cartridge containing a tape containing an aerosol-generating substrate. The aerosol-generating system has a cartridge received within the cartridge receiving cavity. When the cartridge is received within the cavity, the inductive heating element is in magnetic contact with the tape. When the inductive heating element is in magnetic contact with the tape, the inductive heating element is capable of inducing heat in a susceptor element in or on the tape. That is, the tape may have multiple layers and the susceptor element may be between layers of the tape. Alternately, the susceptor element may be in or on the aerosol-generating substrate. The cartridge includes a tape extending from a first end to a second end, a rotatable supply reel fixed within the cartridge, a rotatable take-up reel fixed within the cartridge, and the first end of the tape fixed to the take-up reel and the second end of the tape fixed to the supply reel. An aerosol-generating substrate is disposed on the tape. The aerosol-generating substrate Includes nicotine and glycerol. The susceptor element comprises a plurality of ferritic stainless-steel beads is disposed within the aerosol-generating substrate or within the tape.

According to another aspect of the present invention, a method of using the aerosol-generating system described herein includes rotating the take-up reel to move the tape forward and to align the inductive heating element with the aerosol-generating substrate and heating the aerosol-generating substrate by creating a magnetic field induced by the inductive heating element to heat the susceptor, such as a plurality of ferritic stainless-steel beads and thereby heating the aerosol-generating substrate to form an aerosol in an inhalation airflow.

According to another aspect of the present invention, the aerosol-generating substrate may be solid at 25° C.

Advantageously, the aerosol-generating substrate does not liquefy or create aerosol until the heating step and is thus stable and does not leak liquid during transport or storage of the aerosol-generating substrate. In addition, the replaceable cartridge does not include an inductive heating element and is therefore less complex and less costly to produce. Instead, the inductive heating element is in the aerosol-generating device and is reusable with multiple replaceable cartridges. In addition, each replaceable cartridge provides a metered dose of aerosol-generating substrate per inhalation or puff as the tape is incrementally rotated past the heating element by the user.

All values reported as a percentage are presumed to be weight percent based on the total weight.

All scientific and technical terms used herein have meanings commonly used in the art unless otherwise specified. The definitions provided herein are to facilitate understanding of certain terms used frequently herein.

As used herein, the singular forms “a”, “an”, and “the” encompass embodiments having plural referents, unless the content clearly dictates otherwise.

As used herein, “or” is generally employed in its sense including “and/or” unless the content clearly dictates otherwise. The term “and/or” means one or all the listed elements or a combination of any two or more of the listed elements.

As used herein, “have”, “having”, “include”, “including”, “comprise”, “comprising” or the like are used in their open-ended sense, and generally mean “including, but not limited to”. It will be understood that “consisting essentially of”, “consisting of”, and the like are subsumed in “comprising,” and the like.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

The term “substantially” as used here has the same meaning as “significantly,” and can be understood to modify the relevant term by at least about 90%, at least about 95%, or at least about 98%. The term “not substantially” as used here has the same meaning as “not significantly,” and can be understood to have the inverse meaning of “substantially,” i.e., modifying the relevant term by not more than 10%, not more than 5%, or not more than 2%.

The terms “upstream” and “downstream” refer to relative positions of elements of the inhaler device and inhaler systems described in relation to the direction of inhalation air flow as it is drawn through the body of the inhaler device and inhaler systems.

The term “solid” refers to a fundamental state of matter that does not expand to fill a space or flow, at a temperature of 25 degrees Celsius and one atmosphere pressure.

The term “nicotine” refers to nicotine and nicotine derivatives such as free-base nicotine, nicotine salts and the like.

As used herein, the terms “control electronics”, “controller” and “processor” refer to any device or apparatus capable of providing computing capabilities and control capabilities suitable, or configurable to perform the methods, process, and techniques described herein such as, for example, microprocessors, digital signal processors (DSP), application specific integrated circuits (ASIC), field-programmable gate arrays (FPGA), equivalent discrete or integrated logic circuitry, or any combination thereof and of providing suitable data storage capabilities that includes any medium (for example, volatile or non-volatile memory, or magnetic recordable medium such as a disk or tape) containing digital bits (for example, encoded in binary or trinary) that may be readable and writeable.

The term “aerosol” is used here to refer to a suspension of solid particles or liquid droplets, or a combination of solid particles and liquid droplets in a gas. The gas may be air. The solid particles or liquid droplets may comprise one or more volatile flavor compounds. Aerosol may be visible or invisible. Aerosol may include vapors of substances that are ordinarily liquid or solid at room temperature. Aerosol may include vapors of substances that are ordinarily liquid or solid at room temperature, in combination with solid particles or in combination with liquid droplets or in combination with both solid particles and liquid droplets. The aerosol preferably comprises nicotine.

The term “aerosol-generating substrate” is used here to refer to a material capable of releasing one or more volatile compounds that can form an aerosol. In some embodiments, an aerosol-generating substrate may be heated to volatilize one or more components of the aerosol-generating substrate to form an aerosol. In some cases, volatile compounds may be released by a chemical reaction. Aerosol-generating substrate may be solid or liquid or may comprise both solid and liquid components such as a gel. Aerosol-generating substrate may be adsorbed, coated, impregnated, or otherwise loaded onto a carrier or support. Aerosol-generating substrate preferably comprises nicotine. Aerosol-generating substrate may comprise plant-based material. Aerosol-generating substrate may comprise tobacco. Aerosol-generating substrate may comprise a tobacco-containing material containing volatile tobacco flavor compounds, which are released from the aerosol-generating substrate upon heating. Aerosol-generating substrate may alternatively comprise a non-tobacco-containing material. Aerosol-generating substrate may comprise homogenized plant-based material. Aerosol-generating substrate may comprise homogenized tobacco material. Aerosol-generating substrate may comprise at least one aerosol-former. Aerosol-generating substrate may comprise other additives and ingredients, such as flavorants. The aerosol-generating substrate may comprise an active ingredient. The aerosol-generating substrate may be provided as part of an aerosol generating article. The aerosol-generating substrate may be provided in an aerosol-generating article.

The term “aerosol-generating article” is used here to refer to a disposable product capable of including (for example, holding, containing, having, or storing) aerosol-generating substrate. An aerosol-generating article may be capable of removably interfacing, or docking, with an aerosol generating device. This allows the aerosol-generating device to generate aerosol from the aerosol-generating substrate of the aerosol-generating article. An “aerosol-generating cartridge” or a “cartridge” are examples of an “aerosol-generating article”.

The term “aerosol-generating device” is used here to refer to any device configured to be used or utilized with an aerosol forming substrate that releases volatile compounds to form an aerosol that may be inhaled by a user. The aerosol-generating device may be interfaced with an aerosol-generating article comprising the aerosol-generating substrate.

The term “inductive heating element” or “inductive heater” (these terms are used interchangeably) is used here to refer to a work coil or an inductive coil (which can be in many forms, as described below) which generates an alternating magnetic field when an alternating current flows through the coil. This alternating magnetic field induces eddy currents in susceptor materials that are positioned within the generated magnetic field.

The term “susceptor” or “susceptor element” (these terms are used interchangeably) is used here to refer to metallic or magnetic material which heat up when exposed to the alternating magnetic field generated by the inductive heating element.

The term “magnetically coupled” or “in magnetic contact” is used here to refer to the placement of susceptor(s) within the magnetic field generated by the inductive heating element or inductive heater. If the susceptor is magnetically coupled with the inductive heating element, the susceptor will heat up. If the susceptor is in magnetic contact with the inductive heating element, the susceptor will heat up. The susceptor heats as a result of eddy currents induced in the susceptor as a result of exposure to the magnetic field created by the inductive heating element.

An aerosol-generating system includes an inductive heating element in the aerosol-generating device that receives the replaceable aerosol-generating article. The replaceable aerosol-generating article includes a tape having an aerosol-generating substrate on a tape. The aerosol-generating substrate may be solid at room temperature. The solid aerosol-generating substrate remains solid until it is heated. A susceptor element is provided in or on the tape. Alternatively, or in addition to, the susceptor element is provided in or on the aerosol-generating substrate. In embodiments, the susceptor element is a plurality of ferritic stainless-steel beads disposed within or on the solid aerosol-generating substrate, or in or on the tape. The inductive heating element magnetically contacts and inductively heats the susceptor element. The susceptor element heats the aerosol-generating substrate at a temperature sufficient to vaporize the solid aerosol-generating substrate, preferably in a range from about 200 degrees to about 450 degrees Celsius. The susceptor heats the aerosol-generating substrate in a range from 200 degrees to 350 degrees Celsius. The susceptor heats the aerosol-generating substrate in a range from 200 degrees to 300 degrees Celsius. The vaporized aerosol-generating substrate forms an aerosol that is carried into the airflow toward the air outlet of the mouthpiece of the aerosol-generating device.

An aerosol-generating system including an aerosol-generating device and a replaceable cartridge. The aerosol-generating device includes a housing having a mouthpiece or air outlet. The aerosol-generating device includes an inhalation air inlet. The aerosol-generating device includes an airflow channel fluidly connecting the air outlet with the air inlet. The aerosol-generating device includes an inductive heating element coupled to the housing and along the airflow channel. The aerosol-generating device includes a cartridge receiving cavity defined withing the housing and configured to receive the cartridge containing a tape having an aerosol-generating substrate. The cartridge is received within the cartridge receiving cavity so that the inductive heating element creates a magnetic field in close enough proximity with susceptor(s) in or on the tape or in or on the aerosol-generating substrate disposed on the tape to create eddy currents in the susceptor(s) and to heat the susceptor(s). That is, the susceptor(s) are in magnetic contact with the inductive heating element.

The cartridge includes a rotatable supply reel fixed within the cartridge, a rotatable take-up reel fixed within the cartridge, and a tape disposed on the supply reel and the take-up reel. The tape extends from a first end to a second end. The first end of the tape is fixed to the take-up reel and the second end of the tape is fixed to the supply reel. The tape includes an aerosol-generating substrate disposed on the tape. The solid aerosol-generating substrate includes nicotine and glycerol. The aerosol-generating substrate may be solid at room temperature.

A susceptor element is disposed on or within the aerosol-generating substrate. The aerosol-generating substrate may be solid at room temperature. A susceptor element is disposed on the tape. The susceptor element is a metallic or magnetic material which heat up when exposed to the alternating magnetic field generated by the inductive heating element.

Examples of susceptor materials may include conductive carbon such as graphite, aluminum, stainless steel, copper, bronze, or any combination thereof. Preferably the susceptor material is a magnetic stainless-steel material.

The susceptor may be beads, continuous fibers, broken fibers, particles, or any combination thereof. The susceptor may be a plurality of elements not in a conductive relationship with one another to reduce undesired conductive heating of neighboring, non-target susceptors. The susceptor may be inter posed in patterns to delineate target areas to be inductively heated. Preferably the susceptor material are beads or spherical particles.

The susceptor element may be a plurality of ferritic stainless-steel beads. The plurality of ferritic stainless-steel beads may be disposed within the aerosol-generating substrate. The plurality of ferritic stainless-steel beads may be disposed adjacent the aerosol-generating substrate. The plurality of ferritic stainless-steel beads may be disposed on the tape. The plurality of ferritic stainless-steel beads may be disposed within the tape, or between layers of the tape. The plurality of ferritic stainless-steel beads may be disposed on the tape. The plurality of ferritic stainless-steel beads may be disposed on or within both the solid aerosol-generating substrate and the tape.

The inductive heating element includes one or more inductive coils. The inductive heating element generates heat by inductively heating the susceptor element. For example, the inductive heating element generates heat by generating an alternating magnetic field and induces eddy currents in the susceptor such as ferritic stainless-steel beads when the ferritic stainless-steel beads are disposed within the alternating magnetic field. The susceptor such as ferritic stainless-steel beads may be disposed within or on the tape. The susceptor such as ferritic stainless-steel beads may be disposed within or on the aerosol-generating substrate. Inductive heating of the susceptor such as ferritic stainless-steel beads vaporize the aerosol-generating substrate proximate or in contact with the susceptor such as ferritic stainless-steel beads. The inductive heating element is electrically coupled to a power supply in the aerosol-generating device.

The inductive heating element may have a surface area in a range from about 20 mm₂ to about 100 mm², or from about 40 mm² to about 80 mm₂, for example. The inductive heating element may operate at a frequency in a range from 5 MHz to 30 Mhz. The inductive heating element may operate at a frequency in a range from 6 MHz to 15 Mhz. The inductive heating element may operate at a frequency in a range from 6 MHz to 7 Mhz. The inductive heating element may operate at a frequency in a range from 13 MHz to 14 Mhz. The inductive heating element may operate at a frequency in a range from 26 MHz to 27 Mhz.

The inductive heating element may be a flat coil. The inductive heating element may be a single flat coil providing an alternating magnetic field to the susceptor element in the tape or aerosol-generating substrate. The inductive heating element may be a single flat coil providing an alternating magnetic field to the susceptor element in the tape or aerosol-generating substrate. The inductive heating element may be two or more flat coils in series along a single side of the tape and providing an alternating magnetic field to the susceptor element in the tape or aerosol-generating substrate. The susceptor element is preferably a plurality of ferritic stainless-steel beads disposed within the solid aerosol-generating substrate or within the tape.

The inductive heating element may be two or more flat coils in series along a single side of the tape and providing an alternating magnetic field to the susceptor element in the tape or aerosol-generating substrate. The inductive heating element may be a single flat coil providing an alternating magnetic field to the susceptor element in the tape or aerosol-generating substrate. The susceptor element is preferably a plurality of ferritic stainless-steel beads disposed within the solid aerosol-generating substrate or within the tape.

The inductive heating element may be a U-shaped coil, partially surrounding the tape and providing an alternating magnetic field to the susceptor element in the tape or aerosol-generating substrate. The inductive heating element may be a U-shaped coil, partially surrounding the tape and providing an alternating magnetic field to the susceptor element on the tape or aerosol-generating substrate. The susceptor element is preferably a plurality of ferritic stainless-steel beads disposed within the solid aerosol-generating substrate or within the tape.

The inductive heating element may be two or more flat coils along both sides of the tape (where the tape separates opposing flat magnetic coils) and providing an alternating magnetic field to the susceptor element on the tape or aerosol-generating substrate. The inductive heating element may be two or more flat coils along both sides of the tape (where the tape separates opposing flat magnetic coils) and providing an alternating magnetic field to the susceptor element in the tape or aerosol-generating substrate. Alternatively, the inductive heating element may be a coil that surrounds the tape. The susceptor element is preferably a plurality of ferritic stainless-steel beads disposed within the solid aerosol-generating substrate or within the tape.

The inductive heating element may be separated from the tape. For example, a plastic spacer may separate the coil or coils from the tape. The plastic spacer may have a thickness in a range from 100 to 500 micrometers, or from 250 to 350 micrometers, for example. If present, the spacer should be sized so that the magnetic field generated by the inductive heating element can reach the susceptor element or elements so as to effect heating of the susceptor element and the aerosol-generating substrate. The coil or coils and the susceptor element may be separated by a distance from 100 to 1000 micrometers, or from 500 to 1000 micrometers. The tape may be in contact with the inductive heating element. The inductive heating element may contact the tape. The inductive heating element may deflect the tape.

The inductive heating element may be a solenoid coil. The inductive heating element may be a single solenoid coil providing a magnetic field to the plurality of ferritic stainless-steel beads in the tape. The inductive heating element may be a single solenoid coil providing a magnetic field to the plurality of ferritic stainless-steel beads on the tape. The inductive heating element may be a single solenoid coil providing a magnetic field to the plurality of ferritic stainless-steel beads in the aerosol-generating substrate. The inductive heating element may be a single solenoid coil providing a magnetic field to the plurality of ferritic stainless-steel beads on the aerosol-generating substrate.

The inductive heating element may be two or more solenoid coils in series along a single side of the tape and providing an alternating magnetic field to the susceptor element in or on the tape. The inductive heating element may be two or more solenoid coils in series along a single side of the tape and providing an alternating magnetic field to the susceptor element in or on. The inductive heating element may be two or more solenoid coils in series along a single side of the tape and providing an alternating magnetic field to the susceptor element in or on the aerosol-generating substrate. The inductive heating element may be two or more solenoid coils in series along a single side of the tape and providing an alternating magnetic field to the susceptor element in or on the aerosol-generating substrate.

A plastic spacer may separate the solenoid coil or coils from the tape. If present, the spacer should be sized so that the magnetic field generated by the inductive heating element can reach the susceptor element so as to effect heating of the susceptor element and the aerosol-generating substrate. The plastic spacer may have a thickness in a range from 100 to 500 micrometers, or from 250 to 350 micrometers, for example. The solenoid coil or coils and the susceptor element may be separated by a distance from 100 to 1000 micrometers, or from 500 to 1000 micrometers. The tape may be in contact with the inductive heating element. The inductive heating element may contact and deflect the tape. The tape may contact a portion of the perimeter of the inductive heating element. The tape may contact about 25% to about 50% of the perimeter of the inductive heating element.

The susceptor is preferably a plurality of ferritic stainless-steel beads having a number average diameter in a range from 5 micrometers to 50 micrometers, or from 10 micrometers to 40 micrometers, or from 20 micrometers to 35 micrometers. The ferritic stainless-steel beads are generally defining a spherical shape. The ferritic stainless-steel beads are magnetic. The ferritic stainless-steel beads are formed of iron and 16%-18% wt. chromium. These magnetic ferritic stainless-steel beads have been found to be particularly useful as the susceptor element. The plurality of ferritic stainless-steel beads is preferably formed of AISI 430 stainless steel.

The aerosol-generating substrate may contain the ferritic stainless-steel beads. The plurality of ferritic stainless-steel beads may be uniformly distributed within or on the aerosol-generating substrate. The aerosol-generating substrate may contain from 1% to 30% by volume, or from 5% to 20% by volume, or 5% to 15% by volume ferritic stainless-steel beads. The plurality of ferritic stainless-steel beads may be present within the aerosol-generating substrate. The plurality of ferritic stainless-steel beads may be present on the aerosol-generating substrate.

The tape may contain the ferritic stainless-steel beads. The plurality of ferritic stainless-steel beads may be uniformly distributed within or on the tape. The tape may contain from 1% to 30% by volume, or from 5% to 20% by volume, or 5% to 15% by volume ferritic stainless-steel beads. The plurality of ferritic stainless-steel beads may be present within the tape. The plurality of ferritic stainless-steel beads may be present on the tape.

Alternatively, the plurality of ferritic stainless-steel beads may be uniformly distributed within or on the tape and on or in the solid aerosol-generating substrate. The tape and the solid aerosol-generating substrate may contain from 1% to 30% by volume, or from 5% to 20% by volume, or 5% to 15% by volume ferritic stainless-steel beads.

The tape may have multiple layers. The plurality of ferritic stainless-steel beads may be uniformly distributed between the layers of the tape. Alternatively, the tape may be a unitary body formed of a single layer and the plurality of ferritic stainless-steel beads may be uniformly distributed within the tape layer.

As the tape advances from the supply reel to the take-up reel, the tape moves past the inductive heating element to advance the tape to a region of solid aerosol-generating substrate on the tape. The inductive heating element activates and inductively heats the ferritic stainless-steel beads in or on the tape or aerosol-generating substrate to heat the aerosol-generating substrate and form aerosol into inhalation air flowing from the air inlet to the air outlet along the airflow channel.

Rotation of the supply reel or take-up reel, or both may be accomplished by a driving mechanism. The driving mechanism may be coupled to the supply reel, take-up reel, or the heating element, or a combination thereof. The driving mechanism may be coupled to the take-up reel to rotate the take-up reel and the supply reel.

The driving mechanism may be a force applied be the user, such as a trigger or lever element. The driving mechanism may be a force applied by a stored energy element. The driving mechanism may be a force applied by a stored energy element being a wound spring.

The driving mechanism may be electrically coupled to a power supply. The driving mechanism may be a force applied by a linear actuator. The driving mechanism may be a force applied by a motor. The driving mechanism may be a force applied by a linear actuator or motor electrically coupled to a power supply.

The driving mechanism may be electrically coupled to control electronics. The control electronics may be electrically coupled to the inductive heating element. The control electronics may be electrically coupled to the inductive heating element and the driving mechanism. Activation of the driving mechanism may activate the inductive heating element.

The aerosol-generating device may include a controller or control electronics comprising one or more processors (for example, microprocessors). The one or more processors may operate with associated data storage, or memory, for access to processing programs or routines and one or more types of data that may be employed to carry out the illustrative methods. For example, processing programs or routines stored in data storage may include programs or routines for controlling or sensing the heating element and driving mechanism individually controlling the heating element and driving mechanism, implementing programs or schemes using one or more of the heating element and driving mechanism, and the like.

The control electronics may comprise a microprocessor, which may be a programmable microprocessor, a microcontroller, or an application specific integrated chip (ASIC) or other electronic circuitry capable of providing control. The control electronics may comprise further electronic components. The control electronics may be configured to regulate a supply of power to the heating element, driving mechanism and the like. Power may be supplied to the heating element continuously following activation of the system or may be supplied intermittently, such as on a puff-by-puff basis. The power may be supplied to the heating element in the form of pulses of electrical power.

The aerosol-generating device includes a power supply for the heating element and driving mechanism. The power source may be a battery, such as a lithium iron phosphate battery, within the device. As an alternative, the power supply may be another form of charge storage device such as a capacitor. The power supply may require recharging and may have a capacity that allows for the storage of enough energy for one or more smoking experiences. For example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the heating element.

The computer program products used to implement the processes described herein may be provided using any programmable language, for example, a high-level procedural or object orientated programming language that is suitable for communicating with a computer system. Any such program products may, for example, be stored on any suitable device, for example, a storage media, readable by a general or special purpose program, controller apparatus for configuring and operating the computer when the suitable device is read for performing the procedures described herein. In other words, at least in one embodiment, the aerosol-generating device may be implemented using a non-transitory computer readable storage medium, configured with a computer program, where the storage medium so configured causes the computer to operate in a specific and predefined manner to perform functions described herein.

The exact configuration of the controller of the aerosol-generating device is not limiting and essentially any device capable of providing suitable computing capabilities and control capabilities to implement the method may be used. In view of the above, it will be readily apparent that the functionality may be implemented in any manner as would be known to one skilled in the art. As such, the computer language, the controller, or any other software/hardware which is to be used to implement the processes described herein shall not be limiting on the scope of the systems, processes, or programs (for example, the functionality provided by such processes or programs) described herein. The methods and processes described in this disclosure, including those attributed to the systems, or various constituent components, may be implemented, at least in part, in hardware, software, firmware, or any combination thereof. For example, various embodiments of the techniques may be implemented within one or more processors, including one or more microprocessors, DSPs, ASICs, FPGAs, CPLDs, microcontrollers, or any other equivalent integrated or discrete logic circuitry, as well as any combinations of such components. When implemented in software, the functionality ascribed to the systems, devices, and methods described in this disclosure may be embodied as instructions on a computer-readable medium such as RAM, ROM, NVRAM, EEPROM, FLASH memory, magnetic data storage media, optical data storage media, or the like. The instructions may be executed by one or more processors to support one or more embodiments of the functionality.

The inductive heating element is configured to heat the aerosol-generating substrate to at least 200 degrees Celsius within 300 milliseconds. The inductive heating element may be configured to heat the aerosol-generating substrate to at least 250 degrees Celsius within 200 milliseconds, or within 100 milliseconds, or within 50 milliseconds, or within 25 milliseconds.

The cartridge includes a rotatable supply reel fixed within the cartridge, a rotatable take-up reel fixed within the cartridge, and a tape disposed on the supply reel. The tape extends from a first end to a second end. The first end is fixed to the take-up reel and the second end is fixed to the supply reel. The tape includes an aerosol-generating substrate disposed on the tape. The aerosol-generating substrate includes nicotine and glycerol.

The tape may be formed of a material that does not decompose or ignite at the heating temperature. The tape may be formed of a metal. The tape may be formed of carbon fibre.

The tape has a thickness in a range from about 25 micrometres to about 1000 micrometres, or from about 50 micrometres to about 750 micrometres, or from about 100 micrometres to about 500 micrometres, or about 300 micrometres.

The aerosol-generating substrate is a layer, preferably a solid layer (at room temperature) disposed on the tape. The aerosol-generating substrate may have a thickness in a range from 100 micrometres to 750 micrometres, or from 200 micrometres to 500 micrometres.

The aerosol-generating substrate may define a continuous layer disposed on the tape.

The aerosol-generating substrate may define discrete areas on the tape. Each discrete area of aerosol-generating substrate may have an area in a range from about 20 mm² to about 100 mm², or from about 40 mm² to about 80 mm², for example.

The aerosol-generating substrate may be the tape. The aerosol-generating substrate as tape may incorporate the susceptor element. The susceptor element may be continuous fibers. The susceptor element may be broken fibers. The susceptor element may be particles. The susceptor element may be wires. The fibers or wires may be round or flat in cross-section. The susceptor element may be combinations of beads, particles, fibers or wires. The susceptor element may be arranged in patterns to delineate target areas to be inductively heated.

Each discrete area of aerosol-generating substrate may be separated from each other by a distance sufficient to prevent vaporization of adjacent discrete areas of aerosol-generating substrate during the heating step. Each discrete area of aerosol-generating substrate may be separated from each other by about 1 mm to about 5 mm, or 2 mm to about 5 mm, for example.

A method of using the aerosol-generating system described herein includes rotating the take-up reel to align the inductive heating surface with the solid aerosol-generating substrate and inductively heating the solid aerosol-generating substrate with the inductive heating element and ferritic stainless-steel beads to form an aerosol in an inhalation airflow.

The user may then advance the tape past the inductive heating element an increment to align another dose of aerosol-generating substrate with the inductive heating element so that aerosol is introduced into in the inhalation airflow along the airflow channel of the aerosol-generating device. The rotating step advances the tape an increment from the supply reel to the take-up reel past the inductive heating element to generate a subsequent “puff” of aerosol in an inhalation airflow.

The invention is defined in the claims. However, below there is provided a non-exhaustive listing of non-limiting examples. Any one or more of the features of these examples may be combined with any one or more features of another example, embodiment, or aspect described herein.

Example Ex1. An aerosol-generating system includes an aerosol-generating device and a replaceable cartridge. The aerosol-generating device includes a housing having an air outlet and an air inlet, an airflow channel fluidly connecting the air outlet with the air inlet, an inductive heating element is coupled to the housing and along the airflow channel, a cartridge receiving cavity is defined within the housing and configured to receive a cartridge containing a tape containing an aerosol-generating substrate, and a cartridge is received within the cartridge receiving cavity and the inductive heating element is in magnetic contact with the tape. The cartridge includes a tape extending from a first end to a second end, a rotatable supply reel fixed within the cartridge, a rotatable take-up reel fixed within the cartridge, and the first end of the tape is fixed to the take-up reel and the second end of the tape is fixed to the supply reel. An aerosol-generating substrate is disposed on the tape. The aerosol-generating substrate Includes nicotine and glycerol. A plurality of ferritic stainless-steel beads is disposed within the aerosol-generating substrate or within the tape.

Example Ex2. The aerosol-generating system according to Ex1, wherein the aerosol-generating substrate is solid at 25° C.

Example Ex3. The aerosol-generating system according to Ex1 or Ex2, wherein the plurality of ferritic stainless-steel beads has a number average diameter in a range from 5 micrometers to 50 micrometers, or from 10 micrometers to 40 micrometers, or from 20 micrometers to 35 micrometers.

Example Ex4. The aerosol-generating system according to any preceding Example, wherein the plurality of ferritic stainless-steel beads is formed of AISI 430 stainless steel.

Example Ex5. The aerosol-generating system according to any preceding Example, wherein the aerosol-generating substrate contains the ferritic stainless-steel beads.

Example Ex6. The aerosol-generating system according to any preceding Example, wherein the aerosol-generating substrate contains from 1% to 30% by volume, or from 5% to 20% by volume, or 5% to 15% by volume ferritic stainless-steel beads.

Example Ex7. The aerosol-generating system according to any preceding Example, wherein the tape contains the ferritic stainless-steel beads.

Example Ex8. The aerosol-generating system according to any preceding Example, wherein the tape contains from 1% to 30% by volume, or from 5% to 20% by volume, or 5% to 15% by volume ferritic stainless-steel beads.

Example Ex9. The aerosol-generating system according to any preceding Example, wherein the inductive heating element comprises a flat coil.

Example Ex10. The aerosol-generating system according to any preceding Example, wherein the inductive heating element comprises a solenoid coil.

Example Ex11. The aerosol-generating system according to any preceding Example, wherein he inductive heating element is in contact with the tape.

Example Ex12. The aerosol-generating system according to any preceding Example, wherein the inductive heating element contacts and deflects the tape.

Example Ex13. The aerosol-generating system according to any preceding Example, wherein the aerosol-generating device comprises a driving actuator coupled to the take-up reel.

Example Ex14. The aerosol-generating system according to any preceding Example, wherein the inductive heating element operates at a frequency in a range from 5 MHz to 30 MHZ, or from 6 MHz to 15 MHz, or from 6 MHz to 7 Mhz.

Example Ex15. The aerosol-generating system according to any preceding Example, wherein the aerosol-generating device comprises a power supply electrically coupled to the inductive heating element.

Example Ex16. The aerosol-generating system according to any preceding Example, wherein the inductive heating element and ferritic stainless-steel beads are configured to heat the aerosol-generating substrate to 200 degrees C. within 300 milliseconds.

Example Ex17. The aerosol-generating system according to any preceding Example, wherein the tape has a thickness in a range from about 25 micrometres to about 1000 micrometres, or from about 50 micrometres to about 750 micrometres, or from about 100 micrometres to about 500 micrometres, or about 300 micrometres.

Example Ex18. The aerosol-generating system according to any preceding Example, wherein the aerosol-generating substrate has a thickness in a range from 100 micrometres to 750 micrometres, or from 200 micrometres to 500 micrometres.

Example Ex19. A method of using the aerosol-generating system according to any preceding claim, including rotating the take-up reel to rotate the heating element and align the inductive heating element with the aerosol-generating substrate, and heating the aerosol-generating substrate with the inductive heating element and the ferritic stainless-steel beads to form an aerosol in an inhalation airflow.

The Examples will now be further described with reference to the figures in which:

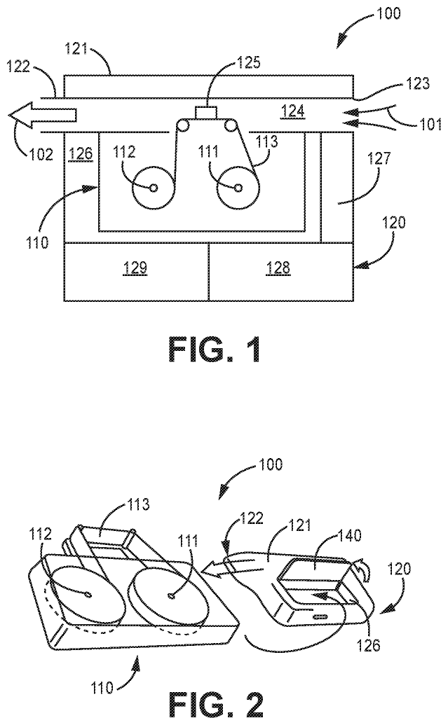

FIG. 1 is a schematic cross-sectional diagram of an illustrative aerosol-generating system;

FIG. 2 is a perspective view of an illustrative aerosol-generating system inserting a cartridge into the aerosol-generating device;

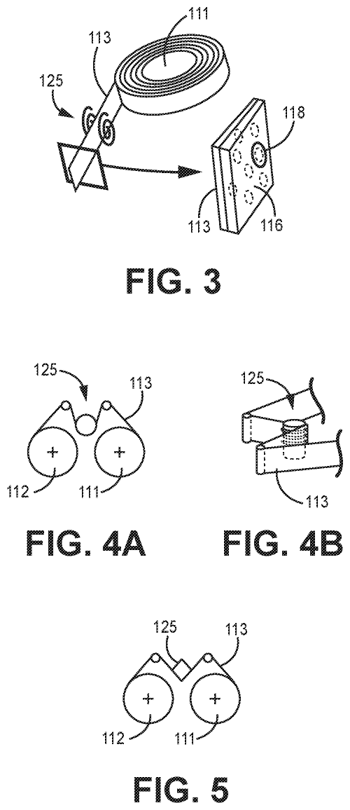

FIG. 3 is a perspective schematic view of tape and a flat coil inductive heating element;

FIG. 4A is a schematic top view of a tape and a solenoid inductive heating element;

FIG. 4B is a perspective view of the tape and a solenoid inductive heating element of FIG. 4A; and

FIG. 5 is a schematic top view of another tape and a solenoid inductive heating element.

The schematic drawings are not necessarily to scale and are presented for purposes of illustration and not limitation. The drawings depict one or more aspects described in this disclosure. However, it will be understood that other aspects not depicted in the drawing fall within the scope and spirit of this disclosure.

FIG. 1 is a schematic cross-sectional diagram of an illustrative aerosol-generating system 100. FIG. 2 is a perspective view of an illustrative aerosol-generating system 100 inserting a cartridge 110 into the aerosol-generating device 120. FIG. 3 is a perspective schematic view of tape 113 and a flat coil inductive heating element 125.

The aerosol-generating system 100 includes an aerosol-generating device 120 and a replaceable cartridge 110. The aerosol-generating device 120 includes a housing 121 having an air outlet 122 and an inhalation air inlet 123, an airflow channel 124 fluidly connecting the air outlet 122 with the air inlet 123. An inductive heating element 125 is coupled to the housing 121 and is located along or in the airflow channel 124. A cartridge receiving cavity 126 is defined withing the housing 121 and configured to receive the cartridge 110 containing a tape 113 containing an aerosol-generating substrate 116. The cartridge 110 is received within the cartridge receiving cavity 126 and the heating element 125 is in magnetic contact with the tape 113. The cartridge 110 includes a rotatable supply reel 111 fixed within the cartridge 110, a rotatable take-up reel 112 fixed within the cartridge 110, and a tape 113 disposed on the supply reel 111. The tape 113 extends from a first end to a second end. The first end is fixed to the take-up reel 112 and the second end is fixed to the supply reel 111. The tape 113 includes an aerosol-generating substrate 116 disposed on the tape 113. The aerosol-generating substrate 116 includes nicotine and glycerol. A susceptor comprising a plurality of ferritic stainless-steel beads 118 are disposed one or within the aerosol-generating substrate 116, or within or on the tape 113.

The aerosol-generating substrate 116 may contain the ferritic stainless-steel beads 118. The plurality of ferritic stainless-steel beads 118 may be uniformly distributed within the solid aerosol-generating substrate 116. The tape 113 may contain the ferritic stainless-steel beads 118. The plurality of ferritic stainless-steel beads 118 may be uniformly distributed within the tape 113. The plurality of ferritic stainless-steel beads 118 may be uniformly distributed within the tape 113 or the solid aerosol-generating substrate 116, or both.

A driving mechanism 127, power supply 128, and control electronics 129 are disposed within the aerosol-generating device 120 housing 121.

FIG. 2 is a perspective view of an illustrative aerosol-generating system 100 inserting a cartridge 110 into the aerosol-generating device 120 cartridge receiving cavity 126. A device lid 140 can be opened to insert the cartridge 110 and then the lid 140 may be closed once the cartridge 110 is seated into the aerosol-generating device 120 cartridge receiving cavity 126.

The inductive heating element 125 includes one or more induction coils configured to inductively heat the plurality of ferritic stainless-steel beads 118 disposed within the solid aerosol-generating substrate 116 or within the tape 113. The plurality of ferritic stainless-steel beads 118 generate heat by inductive heating and heat the solid aerosol-generating substrate 116 to vaporize the aerosol-generating substrate 116 and form aerosol into inhalation air 101 flowing from the air inlet 123 to the mouthpiece or air outlet 122 along the airflow channel 124 and inhalation air 102 flowing out of the air outlet.

The inductive heating element 125 is coupled to the supply reel 111 or take-up reel 112. Rotation of the supply reel 111 or take-up reel 112 may be accomplished by a driving mechanism 127. The driving mechanism 127 may be coupled to the supply reel 111 or take-up reel 112. The driving mechanism 127 may be coupled to the take-up reel 112 to rotate the take-up reel 112 and the supply reel 111. Rotating the take-up reel 112 and the supply reel 111 advances the tape forward to be heated by the inductive heating element 125 to provide solid aerosol-generating substrate 116 for vaporization.

FIG. 4A is a schematic top view of a tape 113 and a solenoid inductive heating element 125. FIG. 4B is a perspective view of the tape 113 and the solenoid inductive heating element 125 of FIG. 4A. FIG. 5 is a schematic top view of another tape 113 and a solenoid inductive heating element 125.

FIG. 4A and 4B illustrates the tape 113 unwinding from the supply reel 111 and winding onto the take-up reel 112 and contacting a circular solenoid inductive heating element 125. The tape 113 is deflected by the solenoid inductive heating element 125 and passes over guide elements on either side of the solenoid inductive heating element 125. The tape 113 contacts about 50% of the perimeter of the circular solenoid inductive heating element 125. The tape 113 contacts the circular solenoid inductive heating element 125.

FIG. 5 illustrates the tape 113 unwinding from the supply reel 111 and winding onto the take-up reel 112 and contacting a lozenge (or square) solenoid inductive heating element 125. The tape 113 is deflected by the solenoid inductive heating element 125 and passes over guide elements on either side of the solenoid inductive heating element 125. The tape 113 contacts about 50% of the perimeter of the lozenge solenoid inductive heating element 125. The tape 113 contacts the circular solenoid inductive heating element 125.

For the purpose of the present description and of the appended claims, except where otherwise indicated, all numbers expressing amounts, quantities, percentages, and so forth, are to be understood as being modified in all instances by the term “about.” Also, all ranges include the maximum and minimum points disclosed and include any intermediate ranges therein, which may or may not be specifically enumerated herein. In this context, therefore, a number A is understood as A +2% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1. An aerosol-generating system comprising:
an aerosol-generating device comprising:
a housing having an air inlet and an air outlet;
an airflow channel fluidly connecting the air outlet with the air inlet;
an inductive heating element coupled to the housing and along the airflow channel;
a cartridge receiving cavity defined withing the housing and configured to receive a cartridge containing a tape containing an aerosol-generating substrate;
a cartridge received within the cartridge receiving cavity and the inductive heating element in magnetic contact with the tape, the cartridge comprising;
a tape extending from a first end to a second end;
a rotatable supply reel fixed within the cartridge;
a rotatable take-up reel fixed within the cartridge;
the first end of the tape fixed to the take-up reel and the second end of the tape fixed to the supply reel;
an aerosol-generating substrate disposed on the tape, the aerosol-generating substrate comprising nicotine and glycerol; and
susceptor elements comprising a plurality of ferritic stainless-steel beads disposed within the aerosol-generating substrate or within the tape.

2. The aerosol-generating system according to claim 1, wherein the aerosol-generating substrate is solid at 25° C.

3. The aerosol-generating system according to claim 1, wherein the plurality of ferritic stainless-steel beads has a number average diameter in a range from 5
micrometers to 50 micrometers.

4. The aerosol-generating system according to claim 1, wherein the plurality of ferritic stainless-steel beads is formed of AISI 430 stainless steel.

5. The aerosol-generating system according to claim 1, wherein the aerosol-generating substrate contains the ferritic stainless-steel beads.

6. The aerosol-generating system according to claim 1, wherein the aerosol-generating substrate contains from 1% to 30% by volume ferritic stainless-steel beads.

7. The aerosol-generating system according to claim 1, wherein the tape contains the ferritic stainless-steel beads.

8. The aerosol-generating system according to claim 1, wherein the tape contains from 1% to 30% by volume ferritic stainless-steel beads.

9. The aerosol-generating system according to claim 1, wherein the inductive heating element comprises a flat coil.

10. The aerosol-generating system according to claim 1, wherein the inductive heating element comprises a solenoid coil.

11. The aerosol-generating system according to claim 1, wherein the inductive heating element contacts and deflects the tape.

12. The aerosol-generating system according to claim 1, wherein the inductive heating element operates at a frequency in a range from 5 MHz to 30 MHz.

13. The aerosol-generating system according to claim 1, wherein the aerosol-generating device comprises a power supply electrically coupled to the inductive heating element, and the inductive heating element and ferritic stainless-steel beads are configured to heat the aerosol-generating substrate to 200 degrees C. within 300 milliseconds.

14. The aerosol-generating system according to claim 1, wherein the tape has a thickness in a range from about 25 micrometres to about 1000 micrometres, and the aerosol-generating substrate has a thickness in a range from 100 micrometres to 750 micrometres.

15. A method of using the aerosol-generating system according to claim 1, comprising:
rotating the take-up reel to rotate the heating element and align the inductive heating element with the aerosol-generating substrate; and
heating the aerosol-generating substrate having the ferritic stainless-steel beads with the inductive heating element form an aerosol in an inhalation airflow.

16. The aerosol-generating system according to claim 2, wherein the plurality of ferritic stainless-steel beads has a number average diameter in a range from 10 micrometers to 40 micrometers.

17. The aerosol-generating system according to any preceding claim 1, wherein the aerosol-generating substrate contains from 5% to 20% by volume ferritic stainless-steel beads.

18. The aerosol-generating system according to any preceding claim 1, wherein the tape contains from 5% to 20% by volume ferritic stainless-steel beads.

19. The aerosol-generating system according to any preceding claim 1, wherein the inductive heating element operates at a frequency in a range from 6 MHz to 15 MHz.

20. The aerosol-generating system according to any preceding claim 1, wherein the tape has a thickness in a range from about 50 micrometres to about 750 micrometres, and the aerosol-generating substrate has a thickness in a range from 200 micrometres to 500 micrometres.
